(19) United States
(12) Patent Application Publication
(10) Pub. No.: US 2018/0347432 A1
(43) Pub. Date: Dec. 6, 2018

(54) CONTROL APPARATUS AND METHOD FOR OPERATING AN INTERNAL COMBUSTION ENGINE

(71) Applicant: GM GLOBAL TECHNOLOGY OPERATIONS LLC, Detroit, MI (US)

(72) Inventors: Andrea DUTTO, Torino (IT); Lucrece Urielle MEKOGUE DONGUE, Turin (IT); Giuseppe GIORDANO, Turin (IT); Cristian TAIBI, Turin (IT)

(73) Assignee: GM GLOBAL TECHNOLOGY OPERATIONS LLC, Detroit, MI (US)

(21) Appl. No.: 15/609,442

(22) Filed: May 31, 2017

(51) Int. Cl. F01N 9/00; F01N 3/021; F02D 41/02; B01D 46/00; B01D 53/94

(52) U.S. Cl. CPC F01N 9/002; F01N 3/021; F02D 41/029; F01N 2900/08; B01D 53/94; F01N 2900/10; F01N 2900/16; B01D 46/0063

(57) ABSTRACT

A control apparatus for operating an internal combustion engine of a vehicle provides regeneration of an after-treatment device associated with the internal combustion engine. A sensor is operably associated with the after-treatment device and provides data indicative of a regeneration requirement of the after-treatment device. An operator interface is configured to provide a regeneration indication to the operator and to accept a regeneration command from the operator. A processor with an associated memory is configured to determine the after-treatment device requires regeneration based upon the data, to assess an operating condition of the vehicle, and to initiate regeneration of the after-treatment device responsive to a regeneration command from the operator.

### TECHNICAL FIELD

The technical field relates to a control apparatus and method for operating an internal combustion engine, and more particularly, to a control apparatus and method for operating an internal combustion engine to provide after-treatment system regeneration.

### BACKGROUND

An internal combustion engine for a motor vehicle generally includes an engine block defining at least one cylinder accommodating a reciprocating piston coupled to rotate a crankshaft. The cylinder is closed by a cylinder head that cooperates with the reciprocating piston to define a combustion chamber. A fuel and air mixture is cyclically disposed in the combustion chamber and ignited, thereby generating hot expanding exhaust gasses that cause the reciprocating movements of the piston. The fuel is injected into each cylinder by a respective fuel injector. The fuel is provided at high pressure to each fuel injector from a fuel rail in fluid communication with a high pressure fuel pump that increases the pressure of the fuel received from a fuel source. Operation of the internal combustion engine is generally controlled by one or more electronic control units (ECUs) operably coupled to an array of sensors and actuators associated with the internal combustion engine.

Due to stringent emissions regulation, internal combustion engines generally include exhaust gas after-treatment systems. An after-treatment system may include one or more after-treatment devices provided in an exhaust system of the internal combustion engine. For example, an after-treatment system may include an oxidation catalyst such as a diesel oxidation catalyst (DOC), that is, a device that utilizes a chemical process to break down compounds within the exhaust stream turning them into generally harmless components. DOCs may have a honeycomb shaped configuration coated in a catalyst designed to trigger the required chemical reaction. DOCs typically contain palladium (Pd) and platinum (Pt) or cerium oxide, which serve as catalysts to oxidize hydrocarbons and carbon monoxide into carbon dioxide and water. An alternative to DOC may be a three-way catalyst (TWC).

In a further alternative, a lean NOx trap (LNT) may be used. A LNT is a device that traps nitrogen oxides (NOₓ) contained in the exhaust gas. More specifically, a LNT is a catalytic device containing catalysts, such as rhodium (Rh), Pt and Pd, and adsorbents, such as barium based elements, which provide active sites suitable for binding the nitrogen oxides (NOₓ) contained in the exhaust gas, in order to trap them within the device itself.

After-treatment systems may also include a diesel particulate filter (DPF) which filters particulate matter (PM) from the exhaust gas and a selective catalytic reduction (SCR) device which is a catalytic device in which the nitrogen oxides (NOₓ) contained in the exhaust gas are reduced into diatomic nitrogen (N₂) and water (H₂O), with the aid of a gaseous reducing agent, typically ammonia (NH₃) that can be obtained by urea (CH₄N₂O) thermo-hydrolysis and that is absorbed inside the SCR. Typically, urea is contained in a dedicated tank and is injected into and mixed with the exhaust gas flow upstream of the SCR. Other fluids can be used in a SCR in lieu of urea, any of which are generally referred to as diesel exhaust fluids (DEF). An alternative to the SCR is a SCRF (SCR on filter), that is, a device that combines in a single unit an SCR and a DPF.

The DPF, whether stand alone or in combination with an SCR, needs to be cleaned periodically. Cleaning of the DPF occurs in a process called regeneration, which is generally triggered automatically by the ECU when a threshold level of contaminants is detected in the DPF and additional operating parameters of vehicle are present. Regeneration may be provided by increasing the exhaust gas temperature to burn (oxidize) the contaminants contained in the DPF. The exhaust gas temperature may be increased by switching the engine from lean operation to rich operation, whereby excess fuel in the exhaust gas as a result of the rich operation is burned in the exhaust system raising the temperature of the exhaust gas.

Certain applications, for example heavy-duty power-take-off (PTO) applications, call for operating the engine while the vehicle is stationary. In this case, an additional operating condition, such as a minimum vehicle speed, is not present and regeneration may be inhibited. Absent regeneration, performance of the engine may be reduced. Moreover, the stationary, heavy-duty use of the vehicle engine leads to an increase in particulate matter that is trapped in the DPF requiring more frequent regeneration. Thus, when regeneration is potentially most beneficial, regeneration is made unavailable due to the operating condition of the vehicle.

### SUMMARY

In accordance with the herein described exemplary embodiments, a control apparatus for operating an internal combustion engine of a vehicle provides regeneration of an after-treatment device associated with the internal combustion engine. A sensor is operably associated with the after-treatment device and is configured to provide data indicative of a regeneration requirement of the after-treatment device. An operator interface is configured to provide a regeneration indication to the operator and to accept a regeneration command from the operator. A processor with an associated memory is configured in accordance with instructions and data stored in the memory to determine the after-treatment device requires regeneration based upon the data; to assess an operating condition of the vehicle; and to initiate regeneration of the after-treatment device responsive to a regeneration command from the operator.

In accordance with the herein described exemplary embodiments, a control apparatus for operating an internal combustion engine of a vehicle provides regeneration of an after-treatment device associated with the internal combustion engine. A sensor is operably associated with the after-treatment device and is configured to provide data indicative of a regeneration requirement of the after-treatment device. An operator interface is configured to provide a regeneration indication to the operator and to accept a regeneration command from the operator. A processor with an associated memory is configured in accordance with instructions and data stored in the memory to determine the after-treatment device requires regeneration based upon the data; to assess an operating condition of the vehicle; and to initiate regeneration of the after-treatment device responsive to a regeneration command from the operator. The operating condition of the vehicle indicates automatic regeneration is prohibited and operator initiated regeneration is permitted.

In accordance with the herein described exemplary embodiments, a control apparatus for operating an internal combustion engine of a vehicle provides regeneration of an after-treatment device associated with the internal combustion engine. A sensor is operably associated with the after-treatment device and is configured to provide data indicative of a regeneration requirement of the after-treatment device. An operator interface is configured to provide a regeneration indication to the operator and to accept a regeneration command from the operator. A processor with an associated memory is configured in accordance with instructions and data stored in the memory to determine the after-treatment device requires regeneration based upon the data; to assess an operating condition of the vehicle; and to initiate regeneration of the after-treatment device responsive to a regeneration command from the operator. The processor is further configured in accordance with the instructions and data to provide an indication of the availability of operator initiated regeneration when automatic regeneration is prohibited.

In accordance with the herein described exemplary embodiments, a control apparatus for operating an internal combustion engine of a vehicle provides regeneration of an after-treatment device associated with the internal combustion engine. A sensor is operably associated with the after-treatment device and is configured to provide data indicative of a regeneration requirement of the after-treatment device. An operator interface is configured to provide a regeneration indication to the operator and to accept a regeneration command from the operator. A processor with an associated memory is configured in accordance with instructions and data stored in the memory to determine the after-treatment device requires regeneration based upon the data; to assess an operating condition of the vehicle; and to initiate regeneration of the after-treatment device responsive to a regeneration command from the operator. The operating condition of the vehicle is one of an idle mode and a power take off (PTO) mode.

In accordance with the herein described exemplary embodiments, a control apparatus for operating an internal combustion engine of a vehicle provides regeneration of an after-treatment device associated with the internal combustion engine. A sensor is operably associated with the after-treatment device and is configured to provide data indicative of a regeneration requirement of the after-treatment device. An operator interface is configured to provide a regeneration indication to the operator and to accept a regeneration command from the operator. A processor with an associated memory is configured in accordance with instructions and data stored in the memory to determine the after-treatment device requires regeneration based upon the data; to assess an operating condition of the vehicle; and to initiate regeneration of the after-treatment device responsive to a regeneration command from the operator. The operating condition of the vehicle is a power take off (PTO) mode and the internal combustion engine is operating with a predetermined power region.

In accordance with the herein described exemplary embodiments, a control apparatus for operating an internal combustion engine of a vehicle provides regeneration of an after-treatment device associated with the internal combustion engine. A sensor is operably associated with the after-treatment device and is configured to provide data indicative of a regeneration requirement of the after-treatment device. An operator interface is configured to provide a regeneration indication to the operator and to accept a regeneration command from the operator. A processor with an associated memory is configured in accordance with instructions and data stored in the memory to determine the after-treatment device requires regeneration based upon the data; to assess an operating condition of the vehicle; and to initiate regeneration of the after-treatment device responsive to a regeneration command from the operator. Regeneration of the after-treatment device may include operating the internal combustion engine at a first speed for a first time period and operating the internal combustion engine at a second speed, different than the first speed, for a second time period.

In accordance with the herein described exemplary embodiments, a control apparatus for operating an internal combustion engine of a vehicle provides regeneration of an after-treatment device associated with the internal combustion engine. A sensor is operably associated with the after-treatment device and is configured to provide data indicative of a regeneration requirement of the after-treatment device. An operator interface is configured to provide a regeneration indication to the operator and to accept a regeneration command from the operator. A processor with an associated memory is configured in accordance with instructions and data stored in the memory to determine the after-treatment device requires regeneration based upon the data; to assess an operating condition of the vehicle; and to initiate regeneration of the after-treatment device responsive to a regeneration command from the operator. The operating condition of the vehicle is stationary.

In accordance with the herein described exemplary embodiments, a control apparatus for operating an internal combustion engine of a vehicle provides regeneration of an after-treatment device associated with the internal combustion engine. A sensor is operably associated with the after-treatment device and is configured to provide data indicative of a regeneration requirement of the after-treatment device. An operator interface is configured to provide a regeneration indication to the operator and to accept a regeneration command from the operator. A processor with an associated memory is configured in accordance with instructions and data stored in the memory to determine the after-treatment device requires regeneration based upon the data; to assess an operating condition of the vehicle; and to initiate regeneration of the after-treatment device responsive to a regeneration command from the operator. The after-treatment device may be a diesel particulate filter (DPF).

In accordance with the herein described exemplary embodiments, a control apparatus for operating an internal combustion engine of a vehicle provides regeneration of an after-treatment device associated with the internal combustion engine. A sensor is operably associated with the after-treatment device and is configured to provide data indicative of a regeneration requirement of the after-treatment device. An operator interface is configured to provide a regeneration indication to the operator and to accept a regeneration command from the operator. A processor with an associated memory is configured in accordance with instructions and data stored in the memory to determine the after-treatment device requires regeneration based upon the data; to assess an operating condition of the vehicle; and to initiate regeneration of the after-treatment device responsive to a regeneration command from the operator. The after-treatment device is a diesel particulate filter (DPF), and the data is indicative of a contamination level of the diesel particulate filter.

In accordance with further herein described exemplary embodiments, a vehicle includes an internal combustion engine, an exhaust system associated with the internal combustion engine, an after-treatment device disposed in the exhaust system, a control apparatus operably coupled to the internal combustion engine and the after-treatment device, and an operator interface is operably coupled to the control apparatus. The control apparatus is configured to provide regeneration of the after-treatment device responsive to an operator initiated regeneration command from the operator interface.

In accordance with further herein described exemplary embodiments, a vehicle includes an internal combustion engine, an exhaust system associated with the internal combustion engine, an after-treatment device disposed in the exhaust system, a control apparatus operably coupled to the internal combustion engine and the after-treatment device, and an operator interface is operably coupled to the control apparatus. The control apparatus is configured to provide regeneration of the after-treatment device responsive to an operator initiated regeneration command from the operator interface. The control apparatus is further configured to provide regeneration response to the operator initiated regeneration command when an operating condition of the vehicle indicates automatic regeneration is prohibited.

In accordance with further herein described exemplary embodiments, a vehicle includes an internal combustion engine, an exhaust system associated with the internal combustion engine, an after-treatment device disposed in the exhaust system, a control apparatus operably coupled to the internal combustion engine and the after-treatment device, and an operator interface is operably coupled to the control apparatus. The control apparatus is configured to provide regeneration of the after-treatment device responsive to an operator initiated regeneration command from the operator interface. The operating condition of the vehicle is one of an idle mode and a power take off (PTO) mode.

In accordance with further herein described exemplary embodiments, a vehicle includes an internal combustion engine, an exhaust system associated with the internal combustion engine, an after-treatment device disposed in the exhaust system, a control apparatus operably coupled to the internal combustion engine and the after-treatment device, and an operator interface is operably coupled to the control apparatus. The control apparatus is configured to provide regeneration of the after-treatment device responsive to an operator initiated regeneration command from the operator interface. The operating condition of the vehicle is a power take off (PTO) mode and the internal combustion engine is operating with a predetermined power region.

In accordance with further herein described exemplary embodiments, a vehicle includes an internal combustion engine, an exhaust system associated with the internal combustion engine, an after-treatment device disposed in the exhaust system, a control apparatus operably coupled to the internal combustion engine and the after-treatment device, and an operator interface is operably coupled to the control apparatus. The control apparatus is configured to provide regeneration of the after-treatment device responsive to an operator initiated regeneration command from the operator interface. The operating condition of the vehicle is stationary.

In accordance with further herein described exemplary embodiments, a vehicle includes an internal combustion engine, an exhaust system associated with the internal combustion engine, an after-treatment device disposed in the exhaust system, a control apparatus operably coupled to the internal combustion engine and the after-treatment device, and an operator interface is operably coupled to the control apparatus. The control apparatus is configured to provide regeneration of the after-treatment device responsive to an operator initiated regeneration command from the operator interface. Regeneration of the after-treatment device may include operating the internal combustion engine at a first speed for a first time period and operating the internal combustion engine at a second speed, different than the first speed, for a second time period.

In accordance with further herein described exemplary embodiments, a vehicle includes an internal combustion engine, an exhaust system associated with the internal combustion engine, an after-treatment device disposed in the exhaust system, a control apparatus is operably coupled to the internal combustion engine and the after-treatment device, and an operator interface is operably coupled to the control apparatus. The control apparatus configured to provide regeneration of the after-treatment device responsive to an operator initiated regeneration command from the operator interface. The after-treatment device may be a diesel particulate filter (DPF).

In accordance with further herein described exemplary embodiments, a vehicle includes an internal combustion engine, an exhaust system associated with the internal combustion engine, an after-treatment device disposed in the exhaust system, a control apparatus is operably coupled to the internal combustion engine and the after-treatment device, and an operator interface is operably coupled to the control apparatus. The control apparatus configured to provide regeneration of the after-treatment device responsive to an operator initiated regeneration command from the operator interface. The data is indicative of a contamination level of the diesel particulate filter.

In accordance with further herein described exemplary embodiment, a method of regenerating an after-treatment device associated with an internal combustion engine of an exhaust system of a vehicle includes determining that automatic regeneration is prohibited and initiating regeneration responsive to an operator initiating regeneration.

In accordance with further herein described exemplary embodiment, a method of regenerating an after-treatment device associated with an internal combustion engine of an exhaust system of a vehicle includes determining that automatic regeneration is prohibited and initiating regeneration responsive to an operator initiating regeneration. Determining that automatic regeneration is prohibited may include determining the vehicle is operating in one of an idle mode and a power take off (PTO) mode.

In accordance with further herein described exemplary embodiment, a method of regenerating an after-treatment device associated with an internal combustion engine of an exhaust system of a vehicle includes determining that automatic regeneration is prohibited and initiating regeneration responsive to an operator initiating regeneration. Determining that automatic regeneration is prohibited may include determining the vehicle is stationary.

### BRIEF DESCRIPTION OF THE DRAWINGS

The present disclosure will hereinafter be described in conjunction with the following drawing figures, wherein like numerals denote like elements.

FIG. 1 is schematic representation of a vehicle incorporating an after-treatment system and an internal combustion engine that are operable in accordance with the herein described embodiments;

FIG. 2 is a block diagram illustration of a method of operating an internal combustion engine in accordance with the herein described embodiments;

FIG. 3 is a diagram depicting operating states of an internal combustion engine in accordance with the herein described embodiments;

FIG. 4 is a graphic depicting operating states of an internal combustion engine in accordance with the herein described embodiments;

FIG. 5 is a diagram depicting operating states of an internal combustion engine in accordance with the herein described embodiments;

FIG. 6 is a diagram depicting operation of an internal combustion engine to affect after-treatment regeneration in accordance with the herein described embodiments; and

FIG. 7 is a graphic depicting icons associated with an after-treatment regeneration control apparatus and method in accordance with the herein described embodiments.

### DETAILED DESCRIPTION OF THE DRAWINGS

The following detailed description is merely exemplary in nature and is not intended to limit the present disclosure or the application and uses of the present disclosure. Furthermore, there is no intention to be bound by any theory presented in the preceding background or the following detailed description. Exemplary embodiments will now be described with reference to the drawings, wherein conventional or commonly known elements may be omitted for clarity.

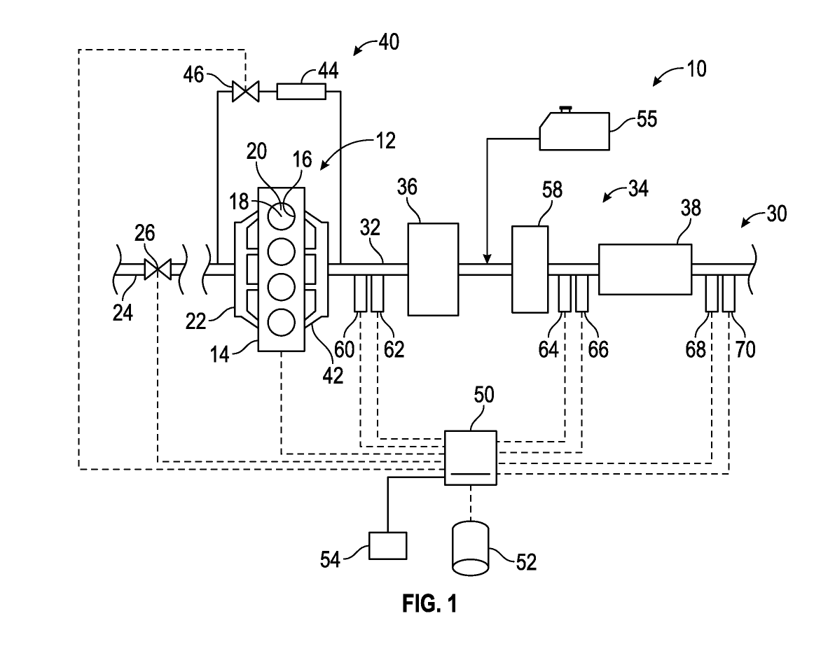

Some embodiments may include a vehicle 10, as shown in FIG. 1 that includes an internal combustion engine (ICE) 12 having an engine block 14 defining at least one cylinder 16 having a piston 18 coupled to rotate a crankshaft. A cylinder head cooperates with the piston 18 to define a combustion chamber 20. A fuel and air mixture is disposed in the combustion chamber 20 and ignited, resulting in hot expanding exhaust gasses causing reciprocal movement of the piston 18. The fuel is provided by at least one fuel injector and the air through at least one intake port from an intake manifold 22. The fuel is provided at high pressure to the fuel injector from a fuel rail in fluid communication with a high-pressure fuel pump that increases the pressure of the fuel received from a fuel source. Each of the cylinders 16 has at least two valves, actuated by a camshaft rotating in time with the crankshaft. The valves selectively allow air into the combustion chamber 20 and alternately allow exhaust gas to exit through an exhaust port.

The air may be distributed to the air intake port(s) through the intake manifold 22. An air intake duct 24 may provide air from the ambient environment to the intake manifold 22. In other embodiments, a throttle body 26 may be provided to regulate the flow of air into the manifold 22. In still other embodiments, a forced air system such as a turbocharger having a compressor rotationally coupled to a turbine may be provided. Rotation of the compressor increases the pressure and temperature of the air in the duct 24 and manifold 22, and an optional intercooler disposed in the duct 24 may be provided to reduce the temperature of the air.

The exhaust system 30 may include an exhaust pipe 32 having an after-treatment system 34 including one or more exhaust after-treatment devices. The after-treatment devices may be any device configured to change the composition of the exhaust gas. Some examples of after-treatment devices include, but are not limited to, catalytic converters (two and three way), such as diesel oxidation catalyst (DOC), lean NOx traps, hydrocarbon adsorbers and selective catalytic reduction (SCR) systems, depicted generally as device 36. The after-treatment system 34 may further include a diesel particular filter (DPF) 38, which may be combined with the SCR to provide an SCRF system. Other embodiments may include an exhaust gas recirculation (EGR) system 40 coupled between the exhaust manifold 42 and the intake manifold 22. The EGR system 40 may include an EGR cooler 44 to reduce the temperature of the exhaust gases in the EGR system 40. An EGR valve 46 regulates a flow of exhaust gases in the EGR system 40.

Upstream of the DPF 38, a urea injection system is provided, the urea injection system including a urea tank 55 and a urea injector 56. Urea is injected in a point upstream of a urea mixer 58 that mixes the urea injected with the exhaust gas stream. An air-to-fuel ratio sensor (or lambda sensor) 60 and an exhaust temperature sensor 62 are provided upstream of the device 36. Furthermore, an air-to-fuel ratio sensor 64 and an exhaust temperature sensor 66 are provided downstream of the device 36. Downstream of the DPF 38, a NOₓ sensor 68 and a particulate matter (PM) sensor 70 are provided.

The vehicle 10 may further include an electronic control unit (ECU) 50 in communication with one or more sensors and/or devices associated with the ICE 12. The ECU 50 may receive input signals from various sensors configured to generate the signals in proportion to various physical parameters associated with the ICE 12. The sensors include, but are not limited to, a mass airflow and temperature sensor, a manifold pressure and temperature sensor, a combustion pressure sensor, coolant and oil temperature and level sensors, a fuel rail pressure sensor, a cam position sensor, a crank position sensor, an exhaust pressure sensor and an exhaust temperature sensor, an EGR temperature sensor, and an accelerator pedal position sensor. Furthermore, the ECU 50 may generate output signals to various control devices that are arranged to control the operation of the ICE 12, including, but not limited to, the fuel injectors, the throttle body 26 and the EGR valve 46. Dashed lines depicted in FIG. 1 are used to indicate communication between the ECU 50 and the various sensors and devices, but some are omitted for clarity.

Turning now to the ECU 50, this apparatus may include a digital central processing unit (CPU) in communication with a memory system 52, and an interface bus. The CPU is configured to execute instructions stored as a program in the memory system 52, and to send and receive signals to/from the interface bus. The memory system 52 may include various storage types including optical storage, magnetic storage, solid-state storage, and other non volatile memory. An operator interface 54, such as an interactive driver information center (DIC), touch screen interface, or any one or combination of display, switches and buttons (not depicted) to provide information to the operator and to accept input from the operator, is operably coupled to the ECU 50. The interface bus may be configured to send, receive, and modulate analog and/or digital signals to/from the various sensors, control devices and the operator interface 54. The program may embody the methods disclosed herein, allowing the CPU to carryout out the steps of such methods and to control the ICE 12.

The program stored in the memory system may be transmitted from outside via a cable or in a wireless interface. Outside the vehicle 10 it is normally visible as a computer program product, which is also called computer readable medium or machine readable medium, and which should be understood to be a computer program code residing on a carrier, whether transitory or non-transitory in nature, with the consequence that the computer program product can be regarded to be transitory or non-transitory in nature.

An example of a transitory computer program product is a signal, e.g. an electromagnetic signal, which is a transitory carrier for the computer program code. Carrying such computer program code can be achieved by modulating the signal by a conventional modulation technique for digital data, such that binary data representing the computer program code is impressed on the transitory electromagnetic signal. Such signals may be made use of when transmitting computer program code in a wireless fashion via a WiFi connection from/to a laptop computer or other computing device.

In the case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an application specific integrated circuit (ASIC), a CD or DVD or the like.

Instead of an ECU 50, the vehicle 10 may have a different type of processor to provide the electronic logic, e.g. an embedded controller, an onboard computer, or any processing module that might be deployed in the vehicle.

During regeneration, the ECU 50 causes the vehicle 10 to operate in such a way to switch the ICE 12 from a lean burn operation to a rich operation. This operation may be implemented without operator intervention when it is determined regeneration is required and when operating conditions permit regeneration, for example, when data from the PM sensor 70 suggests the DPF 38 requires regeneration, when the engine is operating to produce sufficient exhaust energy, and when the vehicle is operating to permit sufficient cooling of the exhaust system 30 and exhaust pipe 32. In accordance with the herein described exemplary embodiments, regeneration may be operator initiated when certain of the above conditions are met and the operator confirms additional conditions exist to permit regeneration.

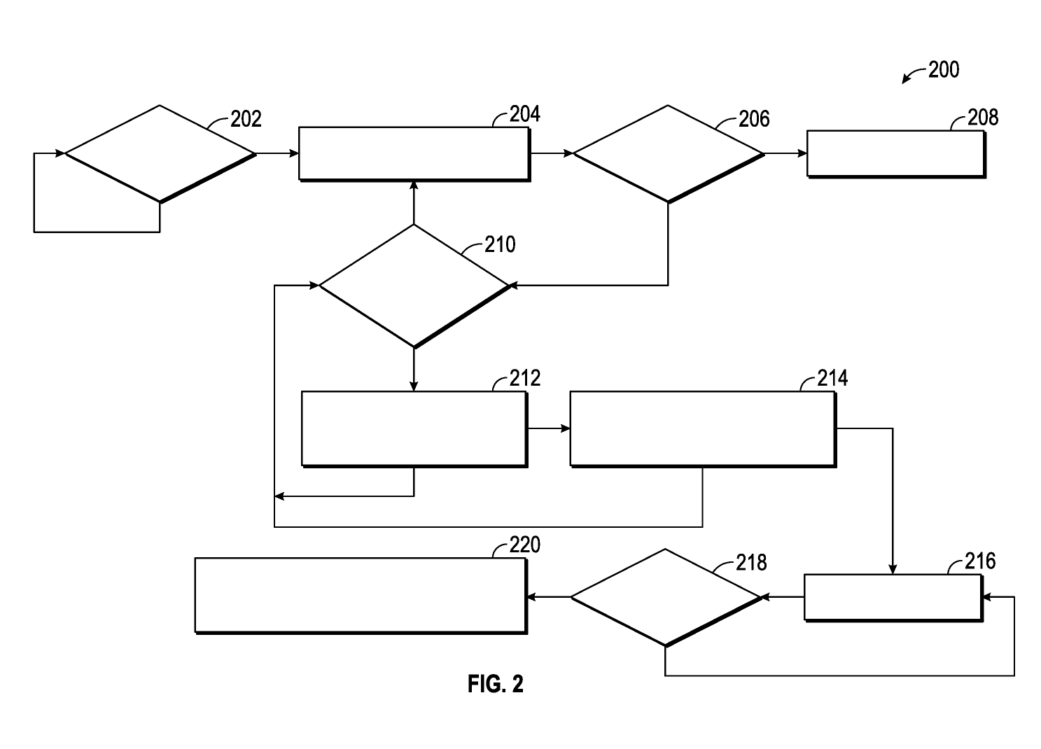

In accordance with the herein described exemplary embodiments, and with reference to FIG. 2, the ECU 50 and memory system 52 may contain program instructions and data that implements through operation of the ECU 50 a method 200 selectively providing operator initiated regeneration of one or more after-treatment devices of the after-treatment system 34, and in particular the DPF 38. Should the ECU 50 determine, according to known procedures, that DPF 38 regeneration is required, 202, the vehicle operator is advised of the requirements and vehicle operating conditions necessary to permit automatic regeneration, 204. If the vehicle is in compliance with the required operating conditions, or is brought into that state, 206, automatic regeneration is initiated, 208.

If the vehicle is not in compliance with the conditions required for automatic regeneration, 204, but conditions are such that operator initiated regeneration is possible, 210, the operator may initiate regeneration 212. If operator initiated regeneration is not possible, 210, the method returns to 204 and the operator is advised to bring the vehicle into compliance with conditions permitting regeneration.

If the operator initiates regeneration, 212, the operator is prompted to confirm additional conditions exist to permits operator initiated regeneration, 212. For example, if the vehicle 10 is stationary with the ICE 12 providing power to a PTO to, for example, lift a dump bed, drive a pump or generator, operate a mechanical arm, or the like, the operator may confirm the exhaust pipe 32 is clear of surrounding objects or debris. With confirmation, 214, operator initiated regeneration occurs 216 and continues until finished, 218. The operator is the notified if the operator initiated regeneration was successful or if additional regeneration steps, automatic or operator initiated are required, 220.

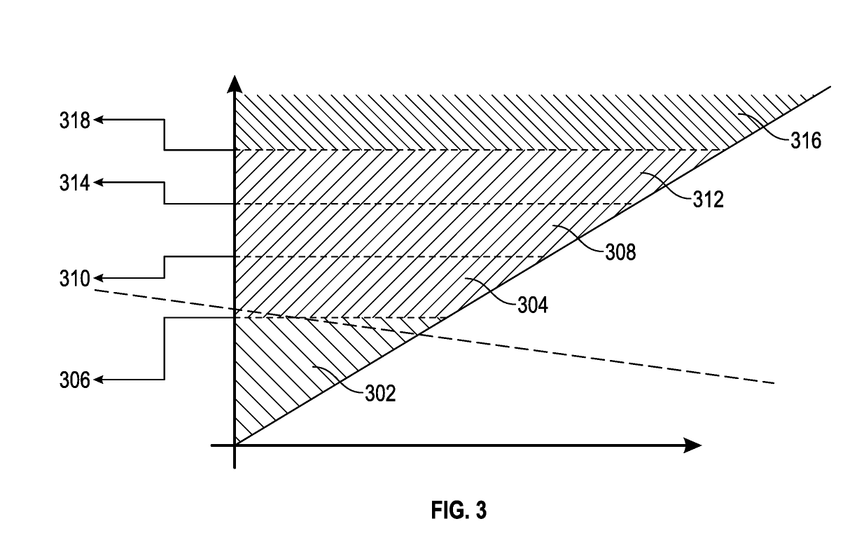

In the Chart 300 depicted in FIG. 3, various levels of DPF 38 contamination levels, e.g., soot levels, (y-axis) are depicted relative to time (x-axis) and informs when automatic regeneration is not possible if manual regeneration is possible (210 of FIG. 2). In a first region 302, the DPF 38 is functionally clean, and regeneration is not required. In a second region 304, a minimum contamination level 306 is attained requiring regeneration. The level 306 may trigger automatic regeneration; however, the operator may not be prompted to initiate regeneration. In region 308, a contamination level 310 is attained and the operator is advised providing that if automatic regeneration is not possible that operator initiated regeneration is possible and suggested. In region 312, a contamination level 314 is attained and providing automatic regeneration is not possible the operator is warned that regeneration is required and to initiate regeneration if conditions permit. In region 316, a contamination level 318 is attained where only automatic regeneration is possible, and in region 320 a contamination level 322 is attained wherein regeneration is not possible, automatic or operator initiated, and vehicle service is required.

The state of the after-treatment device, e.g., DPF 38, as described in connection with the Chart 300 in FIG. 3, is one condition that governs whether operator initiated regeneration is possible. The Chart 400 in FIG. 4 indicates an operating condition of the vehicle 10, e.g., engine torque output (y-axis) versus engine speed, e.g., revolutions per minute (RPM) (x-axis). If the vehicle is operating in an idle region, 402, there may not be enough exhaust energy to effectively regenerate the DPF 38. If the vehicle 10 is being used in a power take off (PTO) mode the engine 12 may be in PTO operating region 404. During PTO usage, the engine 12 output moves into the region 404 reaching a high power output, i.e., high torque output with medium to low engine speed. In this state, while the engine speed may not be sufficient to permit automatic regeneration, the power output may be sufficient to provide sufficient exhaust energy to provide effective operator initiated regeneration. In another region 406, both the engine 12 torque output and speed are sufficient to permit automatic regeneration; however, automatic regeneration may still be inhibited because of the stationary operation of the vehicle 10. This limitation of automatic regeneration, permitting only operator initiated regeneration, is so that further operator input may be received confirming the condition of the vehicle 10 and its surroundings to permit the regeneration function. Hence, it will be appreciated at least three conditions of different values, in the exemplary embodiment contamination level of the DPF 38; idle, PTO or moving operation of the vehicle 10; and engine 12 output, may be required to permit operator initiated regeneration even where automatic regeneration is not recommended or permitted.

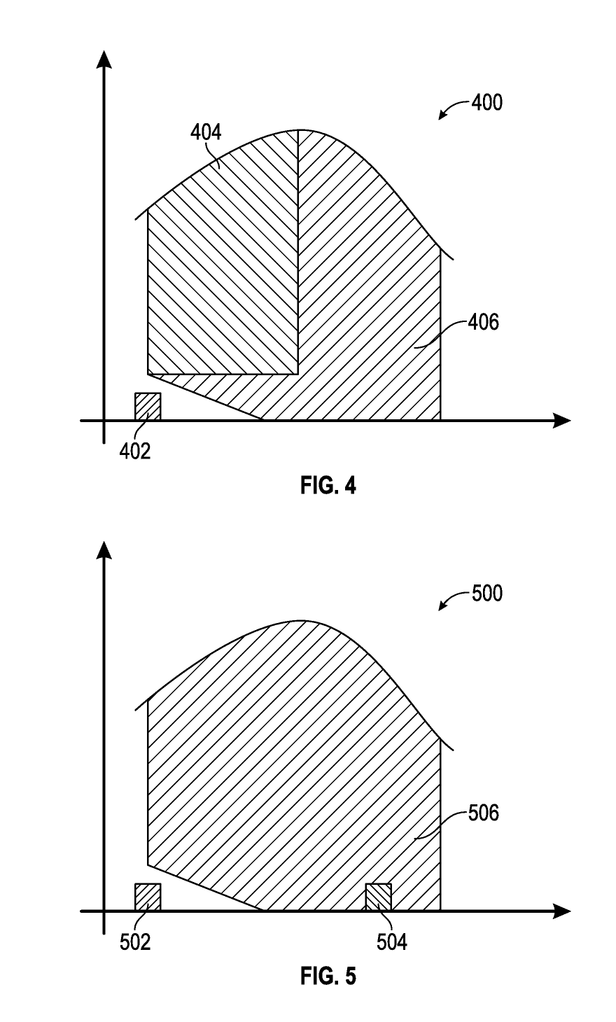

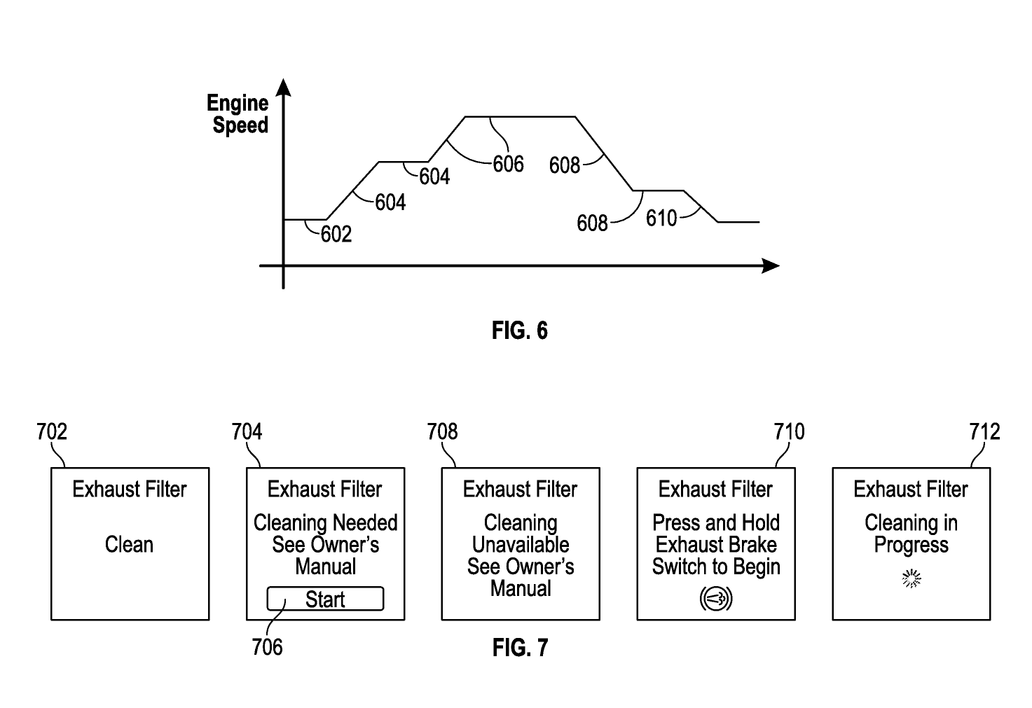

With reference to FIGS. 5 and 6, the vehicle 10 may remain stationary and the engine 12 may be at idle and not in PTO mode. To be able to effectively regenerate the DPF 38, the engine 12 operating point must move so that a condition is created to provide sufficient exhaust energy. In this case, the engine operating condition must move from an idle region 502 to a non-PTO region 504 at which operator initiated regeneration may take place. Similar to the region 406, in region 506, both the engine 12 torque output and speed are sufficient to permit automatic regeneration; however, automatic regeneration may still be inhibited because of the stationary operation of the vehicle 10. This limitation of automatic regeneration, permitting only operator initiated regeneration, is so that the further operator input may be received confirming the condition of the vehicle and its surroundings to permit the regeneration function.

The region 504 may include a plurality of operating states of the engine 12, and for example, six (6) states are indicated in FIG. 6. In the first state 602, the engine 12 is operating at idle. In the second state 604, the engine 12 is ramped to a first level engine speed, e.g., 1500-2500 rpm. Operation of the engine 12 in the second state 604 permits checking of the contamination level of the DPF 38. If the contamination level of the DPF 38 suggests operator initiated regeneration is possible or necessary (e.g., FIG. 2, 210 and FIGS. 3, 310 and 314), in a third state 606 the engine is ramped further to a second level engine speed, e.g., 2500-3000 rpm, sufficient for regeneration. In a fourth state 608, following regeneration, the engine 12 speed is ramped down to a third level engine speed, e.g., 1500-2500 rpm, to allow cool down of the DPF 38, the exhaust system 30 and the engine 12. In a fifth state 610, the engine 12 is ramped further down and back to idle.

From FIGS. 5 and 6, therefore, it can be seen that by operator initiated regeneration it is possible to provide after-treatment regeneration, e.g., regeneration of the DPF 38, while the vehicle 10 remains stationary provide vehicle 10, engine 12 and additional conditions are met.

Operator interaction to effect operator initiated regeneration may be through the operator interface 54 disposed within the vehicle 10. FIG. 7 depicts several graphics that may be depicted on the operator interface 54 to guide the operator through the operator initiated regeneration process. The graphic 702 provides an indication when the after-treatment does not require regeneration, e.g., when the DPF 38 is functionally clean. The graphic 704 provides an indication that regeneration is required, advises the operator to seek additional information and provides a radio button 706 permitting the operator to begin operator initiated regeneration. The graphic 708 guides the operator to further information when, for example, neither operator initiated nor automatic regeneration is possible. The graphic 710 requests the operator confirm vehicle 10 conditions in order to begin operator initiated regeneration (e.g., FIG. 2, 214). The graphic 712 advises the operator that regeneration is active.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A control apparatus for operating an internal combustion engine of a vehicle to provide regeneration of an after-treatment device associated with the internal combustion engine, the apparatus comprising:
a sensor operably associated with the after-treatment device, the sensor configured to provide data indicative of a regeneration requirement of the after-treatment device;
an operator interface configured to provide an regeneration indication to the operator and to accept a regeneration command from the operator; and
a processor with an associated memory, the processor being configured in accordance with instructions and data stored in the memory:
to determine the after-treatment device requires regeneration based upon the data;
to assess an operating condition of the vehicle; and
to initiate regeneration of the after-treatment device responsive an acceptance of the regeneration command by the operator interface.

2. The control apparatus of claim 1, wherein the processor is further configured in accordance with the instructions and data to determine when an automatic regeneration is prohibited and an operator initiated regeneration is permitted based on the operating condition of the vehicle.

3. The control apparatus of claim 1, wherein the processor is further configured in accordance with the instructions and data to provide an indication of the availability of an operator initiated regeneration when an automatic regeneration is prohibited.

4. The control apparatus of claim 1, wherein the operating condition of the vehicle is one of an idle mode and a power take off (PTO) mode.

5. The control apparatus of claim 1, wherein the operating condition of the vehicle is a power take off (PTO) mode and the internal combustion engine is operating within a predetermined power region.

6. The control apparatus of claim 1, wherein the processor is further configured in accordance with the instructions and data to control the regeneration of the after-treatment device by operating the internal combustion engine at a first speed for a first time period and operating the internal combustion engine at a second speed, different than the first speed, for a second time period.

7. The control apparatus of claim 1, wherein the operating condition of the vehicle is stationary.

8. The control apparatus of claim 8, wherein the data is indicative of a contamination level of a diesel particulate filter.

9. A vehicle comprising:
an internal combustion engine,
an exhaust system associated with the internal combustion engine,
an after-treatment device disposed in the exhaust system,
a control apparatus operably coupled to the internal combustion engine and the after-treatment device, and
an operator interface operably coupled to the control apparatus, wherein
the control apparatus is configured to provide regeneration of the after-treatment device responsive to an operator initiated regeneration command from the operator interface.

10. The vehicle of claim 9, control apparatus being further configured to provide regeneration response to the operator initiated regeneration command when an operating condition of the vehicle indicates automatic regeneration is prohibited.

11. The vehicle of claim 10, wherein the operating condition of the vehicle is one of an idle mode and a power take off (PTO) mode.

12. The vehicle of claim 10, wherein the operating condition of the vehicle is a power take off (PTO) mode and the internal combustion engine is operating with a predetermined power region.

13. The vehicle of claim 10, wherein the operating condition of the vehicle is stationary.

14. The vehicle of claim 9, wherein regeneration of the after-treatment device comprises operating the internal combustion engine at a first speed for a first time period and operating the internal combustion engine at a second speed, different than the first speed, for a second time period.

15. The vehicle of claim 9, wherein the after-treatment device comprises a diesel particulate filter (DPF).

16. The vehicle of claim 15, wherein the data is indicative of a contamination level of the diesel particulate filter.

17. A method of regenerating an after-treatment device associated with an internal combustion engine of an exhaust system of a vehicle, the method comprising:
determining that automatic regeneration is prohibited; and
initiating regeneration responsive to an operator initiating regeneration.

18. The method of claim 18, wherein determining that automatic regeneration is prohibited comprises determining that the vehicle is operating in one of an idle mode and a power take off (PTO) mode.

19. The method of claim 18, wherein determining that automatic regeneration is prohibited comprises determining that the vehicle is stationary.
